(19) United States
(12) Patent Application Publication
(10) Pub. No.: US 2026/0329500 A1
(43) Pub. Date: Oct. 22, 2026

(54) COLOR MANAGEMENT METHOD, COLOR MANAGEMENT APPARATUS, AND STORAGE MEDIUM

(71) Applicant: Konica Minolta, Inc., Tokyo (JP)

(72) Inventor: Tomotaka MORIYAMA, Tokyo (JP)

(21) Appl. No.: 19/535,838

(22) Filed: Feb. 10, 2026

(30) Foreign Application Priority Data
Feb. 14, 2025 (JP) 2025-022143

(51) Int. Cl. G06F 3/12; G06F 3/0482

(52) U.S. Cl. CPC G06F 3/1257; G06F 3/0482; G06F 3/1208; G06F 3/1286

(57) ABSTRACT

A color management method includes: receiving, by a color management apparatus, selection of a single first data set to be used for color management; specifying, by the color management apparatus, n image forming apparatuses associated with the selected first data set, the n being greater than one; and performing, by the color management apparatus, the color management based on the first data set for each of the n image forming apparatuses.

### CROSS-REFERENCE TO RELATED APPLICATIONS

The entire disclosure of Japanese Patent Application No. 2025-022143 filed on Feb. 14, 2025 is incorporated herein by reference in its entirety.

### BACKGROUND OF THE INVENTION

### TECHNICAL FIELD

The present disclosure relates to a color management method, a color management apparatus, and a storage medium.

### DESCRIPTION OF RELATED ART

In the printing industry, distributed printing is performed by a plurality of image forming apparatuses (printers) on the basis of the same print data so that a printed material can be created in a short period of time. In distributed printing, uniform color reproducibility is required for a plurality of image forming apparatus.

Japanese Unexamined Patent Publication No. 2004-46339 describes a distributed printing server that generates a color conversion table using standard lookup tables prepared according to the types of printing medium and print mode and correction data sets prepared for individual printers. The distributed server suppresses individual differences in printed results by transmitting, to each of a plurality of printers identified in accordance with operating conditions, a color conversion table corresponding to the printer.

### SUMMARY OF THE INVENTION

However, in the conventional technology, color management is generally performed individually for each image forming apparatus. In order to secure unified color reproducibility for a plurality of image forming apparatuses, it has been necessary to perform color management such as color adjustment and color verification for each image forming apparatus. Therefore, work involved in color management has been complicated in a distributed printing environment. Furthermore, in order to match the color reproducibility of each image forming apparatus, a high level of expertise is required, and there is a problem in that it is difficult for a general operator to cope with this.

The present disclosure has been made in consideration of the above-described problem in the conventional technology, and an object of the present disclosure is to easily perform color management for securing unified color reproducibility for a plurality of image forming apparatus.

To achieve at least one of the abovementioned objects, according to an aspect of the present disclosure, color management method reflecting one aspect of the present disclosure comprises:
receiving, by a color management apparatus, selection of a single first data set to be used for color management;
specifying, by the color management apparatus, n image forming apparatuses associated with the selected first data set, the n being greater than one; and
performing, by the color management apparatus, the color management based on the first data set for each of the n image forming apparatuses.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a system configuration diagram of a color management system in an embodiment of the present disclosure;

FIG. 2 is a block diagram illustrating the functional configuration of a printer;

FIG. 3 is a block diagram illustrating a functional configuration of a PC;

FIG. 4 is an example of setting item of a target configuration;

FIG. 5 is an example of setting item of a color management preset;

FIG. 6 is an image diagram of a color management preset created in the first embodiment;

FIG. 7 is a block diagram illustrating the functional configuration of a server;

FIG. 8 is a flowchart showing the first color management process;

FIG. 9 is a flowchart showing the first color management process;

FIG. 10 is an example of a color management preset registration screen;

FIG. 11 is an example of a color management preset selection screen;

FIG. 12 is an example of the sheet feed tray selection screen;

FIG. 13 is an example of a chart printing screen in color adjustment;

FIG. 14 is an example of a color measurement screen;

FIG. 15 is an example of a profile registration screen;

FIG. 16 is an example of a chart printing screen in color verification;

FIG. 17 is an example of a color verification result screen;

FIG. 18 is an image diagram of a plurality of color management presets created in the second embodiment;

FIG. 19 is a flowchart illustrating the second color management processing; and

FIG. 20 is a flowchart illustrating a second color management process.

### DETAILED DESCRIPTION

Hereinafter, one or more embodiments of the present disclosure will be described with reference to the drawings. However, the scope of the invention is not limited to the disclosed embodiments.

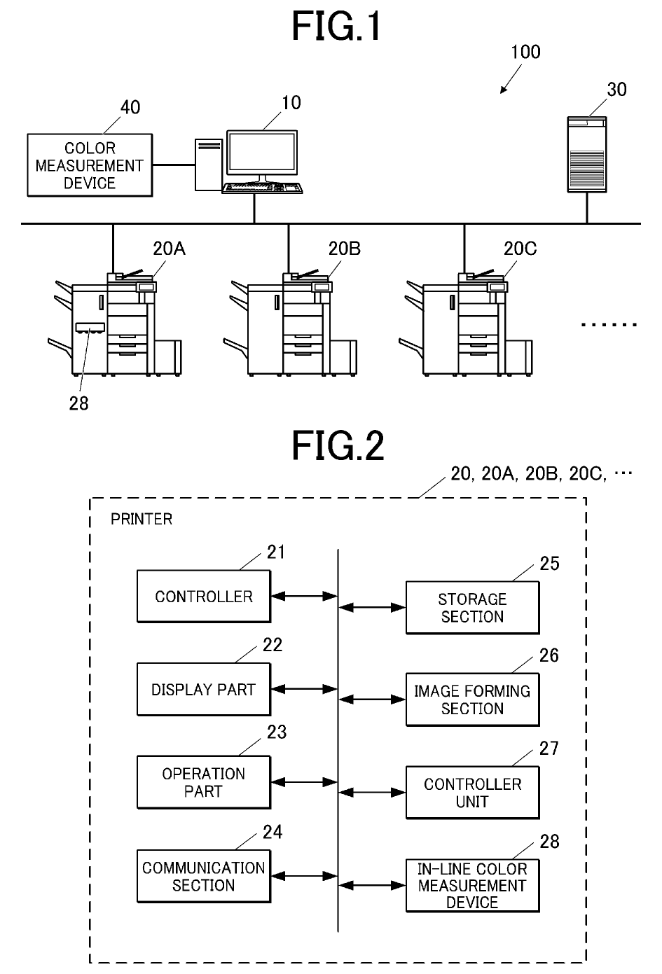

In the following, embodiments of the present disclosure will be described with reference to the drawings. The advantages and features provided by the embodiment will be understood from the following detailed description and the drawings. However, the scope of the present disclosure is not limited to the embodiment disclosed below or the illustrations in the drawings.

[First Embodiment] FIG. 1 is a system configuration diagram of a color management system 100 in a first embodiment. The color management system 100 includes a color management apparatus 10 as a color management apparatus, a plurality of printers 20A, 20B, 20C, and ***, a print server 30, and a color measurement device 40. The PC10, the plurality of printers 20A, 20B, 20C, and ***, and the print server 30 are data-communicably connected via a communication network such as a local area network (LAN). Hereinafter, when the printer 20A, 20B, 20C, and *** are not particularly distinguished from each other, they are referred to as the "printer 20".

The PC10 performs color management of each printer 20. A setting PC10 includes information such as a target configuration and a color management preset as settings used for color management.

The printer 20 is an image forming apparatus that forms an image on a sheet. The printer 20 forms an image based on image data of, for example, cyan (C), magenta (M), yellow (Y), and black (K).

The server 30 causes the two or more printer 20 to perform distributed printing.

The color measurement device 40 is connected to the device PC10 via a USB (Universal Serial Bus) cable or the like. The color measurement device 40 measures a color of a patch group included in a chart printed by the printer 20 and outputs a colorimetric value (L *a*b*value or the like).

FIG. 2 is a block diagram illustrating the functional configuration of the printer 20. The printer 20 includes a controller 21, a display part 22, an operation part 23, a communication section 24, a storage section 25, an image forming section 26, and a controller unit 27.

The controller 21 comprehensively controls the processing operation of each section of the printer 20. The controller 21 includes a central processing unit (CPU), a random access memory (RAM), and the like. Specifically, the CPU reads various program stored in the storage section 25, and develops the program in the RAM. The CPU performs various kinds of processing according to the program.

The display part 22 is configured by a liquid crystal display (LCD). The display part 22 displays various screens according to an instruction of a display signal input from the controller 21.

The operation part 23 receives various operations by a user and outputs an operation signal based on the operation to the controller 21.

The communication section 24 is configured by a network interface or the like. The communication section 24 transmits and receives data to and from an external device connected via a communication network. For example, the communication section 24 receives a print instruction or the like from an external device such as a PC10.

The storage section 25 includes a hard disk drive (HDD), a solid state drive (SSD), and a non-volatile memory. The storage section 25 stores various processing programs and various types of data such as parameters and files necessary for executing the programs. For example, the storage section 25 stores sheet information on the printer 20, adjustment value for color adjustment, a color conversion profile, and the like.

The image forming section 26 forms an image on a sheet by an electrophotographic method. The image forming section 26 includes photosensitive drums corresponding to the respective colors (cyan, magenta, yellow, and black) of toner used for image formation, an intermediate transfer belt, and a fixing section. The image forming section 26 uniformly charges a photosensitive drum corresponding to, for example, cyan, and then scans and exposes the photosensitive drum with a laser beam on the basis of cyan image data to form an electrostatic latent image. The image forming section 26 develops an electrostatic latent image on the photosensitive drum corresponding to cyan by causing cyan toner to adhere to the electrostatic latent image. Processing for the other colors is similar to the processing for cyan. The image forming section 26 sequentially transfers the toner images in respective colors formed on the photoreceptors corresponding to the respective colors onto the intermediate transfer belt (primary transfer). That is, a color toner image in which toner images of a plurality of colors are superimposed is formed on the intermediate transfer belt. The image forming section 26 collectively transfers the color toner image on the intermediate transfer belt onto a sheet (secondary transfer). The image forming section 26 causes the fixing section to fix the color toner image onto the sheet. Controller 21 allows image forming section 26 to form an image based on the image data.

The controller unit 27 generates raster data by performing raster image processor (RIP) processing on print data received from an external device such as a PC10. The controller unit 27 provides the image forming section 26 with the raster data. Note that the controller unit 27 may be another device independent from the printer 20.

The printer 20 may include an inline color measurement device 28. The in-line color measurement 28 is provided on the downstream side of the image forming section 26 in the sheet conveyance route in the printer 20. The in-line color measurement device 28 measures the color of an image on a sheet after image formation, and outputs a colorimetric value(L *a*b*value or the like)^{.}

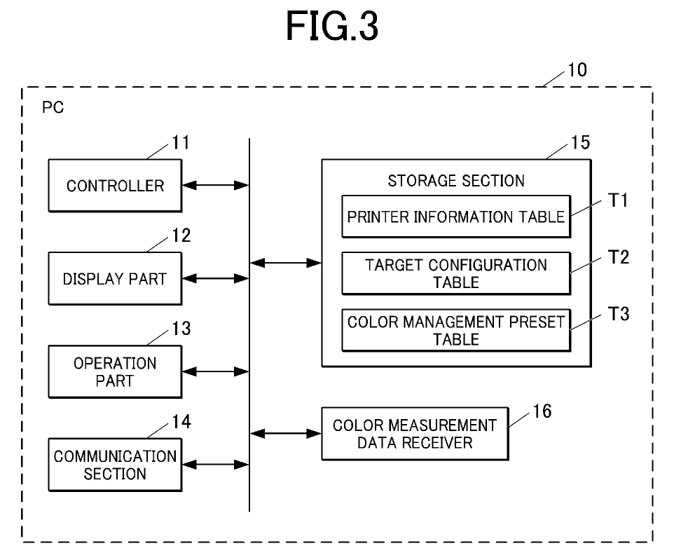

FIG. 3 is a block diagram of a functional configuration of PC10. The PC10 includes a controller 11 (hardware processor), a display part 12, an operation part 13, a communication section 14, a storage section 15, and a color measurement receiver 16.

The controller 11 comprehensively controls processing operation of each part of the PC10. The controller 11 includes a CPU, a RAM, and the like. Specifically, the CPU reads various program stored in the storage section 15, and develops the program in the RAM. The CPU performs various kinds of processing according to the program.

The display part 12 includes a monitor such as an LCD. The display part 12 displays various screens according to an instruction of a display signal input from the controller 11.

The operation part 13 includes a keyboard and a pointing device such as a mouse. The operation part 13 outputs, to the controller 11, a signal based on a key operation on the keyboard and an operation on the pointing device.

The communication section 14 is configured by a network interface or the like. The communication section 14 transmits and receives data to and from an external apparatus such as the printer 20 connected through a network.

The storage section 15 includes an HDD, an SSD, a nonvolatile memory, and the like. The storage section 15 stores various processing programs and various types of data such as parameters and files necessary for executing the programs. For example, the storage section 15 stores a program for a color management application, and the like. The color management application provides a user interface for giving an execution instruction to each color management function of the printer 20, confirming a color measurement result, calculating an adjustment value, and the like.

The storage section 15 stores a printer information table T1, a target configuration table T2, and a color management preset table T3.

The printer information table T1 is a table for managing printer information on the plurality of printers 20 in the color management system 100.

In the printer information table T1, printer names, IP addresses, authentication settings, sheet information, statuses, and the like are associated with each printer 20.

The "printer name" is a name of the printer 20.

The "IP address" is an IP address assigned to the printer 20.

The "authentication setting" is information indicating the authentication setting of the printer 20.

The "sheet information" is information on the sheet to be used in the printer 20. The "sheet information" is information indicating the type of sheet, the sheet feed tray in which the sheet is loaded, and the like. The "sheet information" includes a sheet feed tray, a sheet size, a sheet type, a basis weight, a sheet color, a sheet passing direction, punch holes, and the like.

The "status" is information indicating the state of the printer 20. As the "status", online or offline can be assumed.

The target configuration table T2 is a table for managing a target configuration (color management setting). The target configuration is a first data set used for color management of the printer 20, and is a setting necessary for color management (color adjustment and color verification).

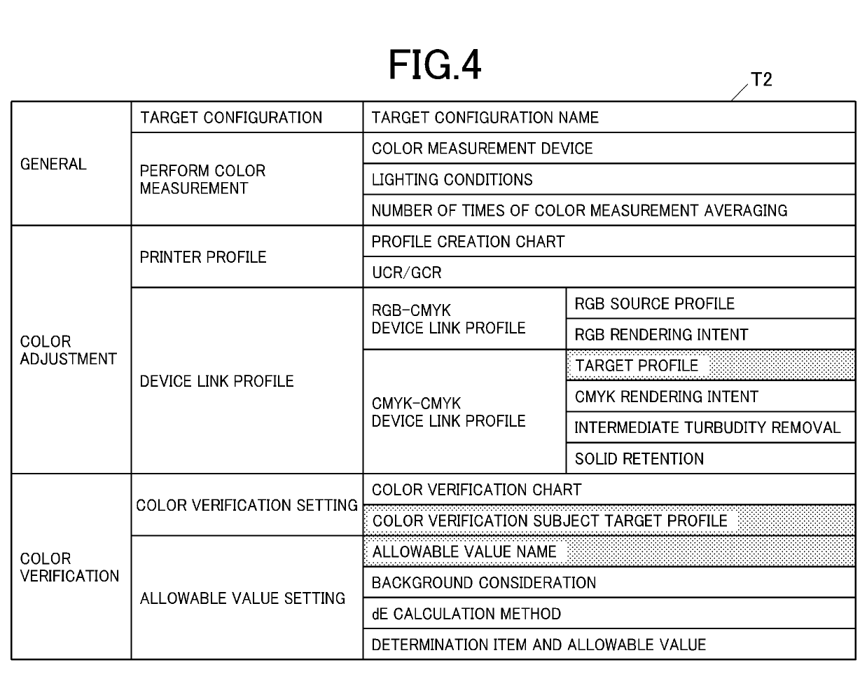

FIG. 4 illustrates an example of setting item of the target configuration managed in the target configuration table T2.

The setting item of the target configuration are classified into "general", "color adjustment", and "color verification".

The "general" includes settings for "target configuration" and "color measurement".

The setting for the "target configuration" includes a "target configuration name".

The "target configuration name" is the name of the target configuration.

The settings for "color measurement" include "color measurement device", "illumination condition", and "the number of times of color measurement averaging".

When the colorimetric value are obtained, in consideration of stability during printing, a plurality of copies of the chart are printed, and the colorimetric value are averaged for each patch. The "number of times of color measurement averaging" is the number of printed copies of the chart used for the averaging.

The "color adjustment" is a setting related to creation of a color conversion profile. The "color adjustment" includes settings for a "printer profile" and a "device link profile".

The settings for the "printer profile" include "profile creation chart" and "UCR/GCR".

The "profile creation chart" is a chart used for creating a color conversion profile (profiling).

"UCR (Under Color Removal)" is to replace CMY of a shadow part with a K plate. "GCR (Gray Component Replacement)" is to replace CMY of all gradation portions from a highlight portion to a shadow portion with a K plate.

The settings for the "device link profile" include settings for the "RGB-CMYK device link profile" and the "CMYK-CMYK device link profile".

The settings for the "RGB-CMYK device-link file" include "RGB source profile" and "RGB rendering intent".

The settings for the "CMYK-CMYK device link profile" include "Target Profile", "CMYK Rendering Intent", "Intermediate Haze Removal", and "Maintain Solid".

The "intermediate turbidity removal" is a setting for reproducing a color constituted by only a single color of CMYK before the color conversion so as to be constituted by only the color after the color conversion.

The "solid retention" is a setting for reproducing a solid portion before color conversion with a solid portion of the color after color conversion.

The "color verification" is a setting related to color verification. The "color verification" includes a "color verification setting" and an "allowable value setting".

The "color verification setting" includes a "color verification chart" and a "color verification target profile".

The "color verification chart" is a chart used for color verification.

The "color verification target profile" is a profile to be targeted in color verification.

The "allowable value setting" includes an "allowable value name", a "base surface consideration", a "dE calculation method", and a "determination item and allowable value".

The "allowable value name" is a name given to the data set related to the setting of the allowable value.

The "determination item and allowable value" are a determination item used for color verification and an allowable value for the item.

The color management preset table T3 is a table for managing the color management preset. The color management preset is information in which a target configuration, a color management target printer, and sheet printing information are associated with each other. The color management preset is a second data set used for color management.

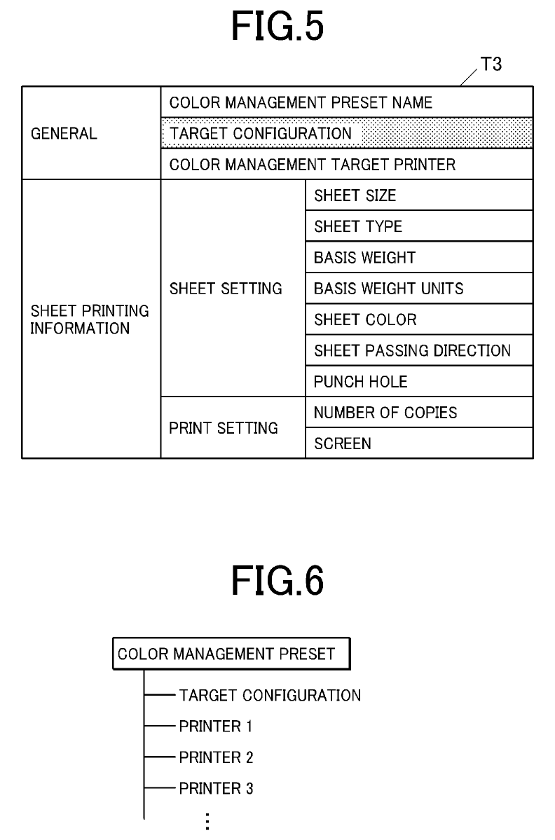

FIG. 5 illustrates an example of setting item of color management presets managed in the color management preset table T3.

The setting item of the color management preset are classified into "general" and "sheet printing information".

The category "general" includes "color management preset name", "target configuration", and "color management target printer".

The "color management preset name" is a name of the color management preset.

The "target configuration" is information indicating the "target configuration" constituting the "color management preset".

The "color management target printer" is information indicating a "printer" constituting a "color management preset". In the first embodiment, a plurality of printers 20 can be set as the "color management target printer".

The "sheet printing information" includes "sheet setting" and "print setting".

The "sheet setting" includes "sheet size", "sheet type", "basis weight", "basis weight unit", "sheet color", "sheet feeding direction", "punch", and the like.

The "print setting" includes "number of copies", "screen", and the like.

The color measurement receiver 16 receives colorimetric values ((L *a*b*value or the like)) from the color measurement device 40.

The controller 11 controls color management (color adjustment and color verification) of each printer 20 connected via the network in cooperation with the program of the color management application.

The controller 11 executes color adjustment on the basis of settings such as the target configuration and the color management preset. The color adjustment includes steps such as printing of a chart, color measurement of the chart, and creation of a color conversion profile.

The controller 11 executes the color verification based on the settings such as the target configuration and the color management preset. The color verification includes steps such as printing of a chart, color measurement of the chart, and calculation of a verification result.

The controller 11 receives a selection of a single target configuration (first data set) to be used for color management.

The controller 11 identifies n printers 20 (image forming apparatus) associated with the selected target configuration. Here, n is an integer greater than 1.

The controller 11 executes color management based on the selected target configuration for each of the n printers 20.

The controller 11 receives selection of a color management preset (second data set) in which the n printers 20 are associated with the target configuration.

The controller 11 executes color management based on the selected color management preset for each of the n printers 20.

The target configuration includes information indicating the color reproduction characteristics of the printer 20 (first image forming apparatus) serving as the standard of color management.

The target configuration includes a setting of a CMYK target profile or a setting of an RGB source profile.

As the color management, the controller 11 creates a color conversion profile for each of the n printers 20 based on the target configuration.

The target configuration includes setting of a target profile or setting of an allowable value in color verification.

As the color management, the controller 11 verifies color reproduction for each of the n printers 20 based on the target configuration.

The color management preset includes at least one setting of a sheet type, a basis weight, and a sheet color of a sheet used for the color management.

The controller 11 executes color management for each of the n printer 20 on the basis of a color management preset.

It is assumed that the PC10 (color management apparatus) can cooperate with m printers 20 (image forming apparatus). Here, m is an integer greater than n. M is the number of printer 20 that can be connected to the PC10 via the communication network in the color management system 100.

In the color management preset, n printers 20 selected from among m printers 20 on the basis of the color reproduction characteristics of the printer 20 (first image forming apparatus) serving as the standard of color management are associated with the target configuration.

FIG. 6 is an image diagram of a color management preset created in the first embodiment. A color management preset is composed of a single target configuration and a plurality of printers 20(n printers 20) in association with each other.

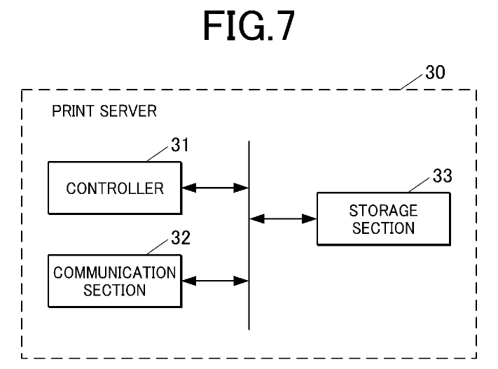

FIG. 7 is a block diagram illustrating the functional configuration of the server 30. The print server 30 includes a controller 31, a communication section 32, and a storage section 33.

The controller 31 comprehensively controls processing operation of each part of the print server 30. The controller 31 includes a CPU and RAM. Specifically, the CPU reads various processing programs stored in the storage section 33, and develops the programs in the RAM. The CPU performs various kinds of processing according to the program.

The communication section 32 is configured by a network interface or the like. The communication section 32 transmits and receives data to and from an external device connected via a communication network.

The storage section 33 includes an HDD, an SSD, a nonvolatile memory, and the like. The storage section 33 stores various processing programs and various types of data such as parameters and files necessary for executing the programs.

The controller 31 performs distributed printing using two or more of the plurality of printers 20 in the color management system 100 on the basis of the same print data.

The controller 31 acquires various types of information (such as printer information) from the printer 20 to be subjected to distributed printing.

The controller 31 selects a plurality of printers 20 to be subjected to distributed printing.

The controller 31 allocates the job to each printer 20 to be subjected to distributed printing.

Next, the operation of the color management system 100 according to the first embodiment will be described.

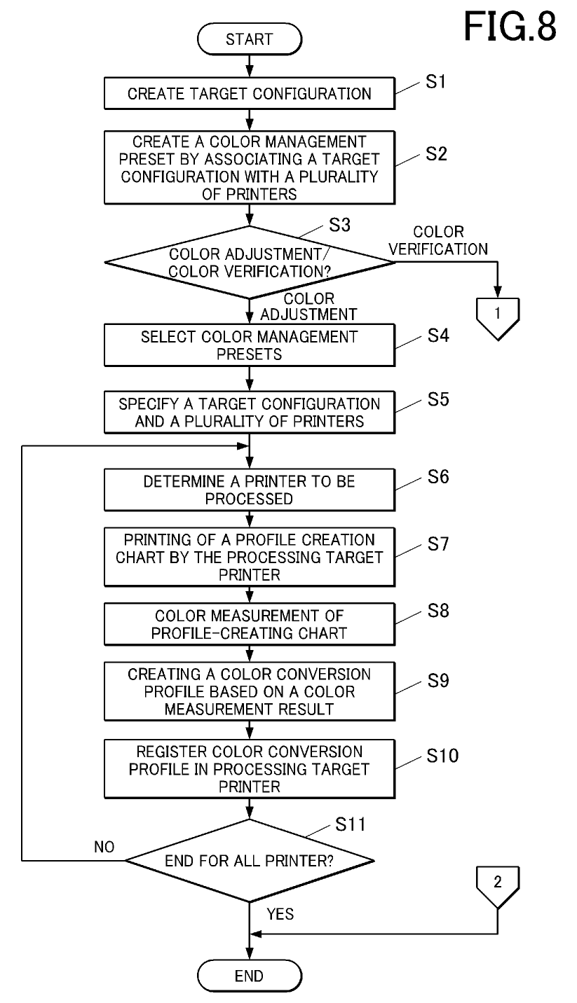

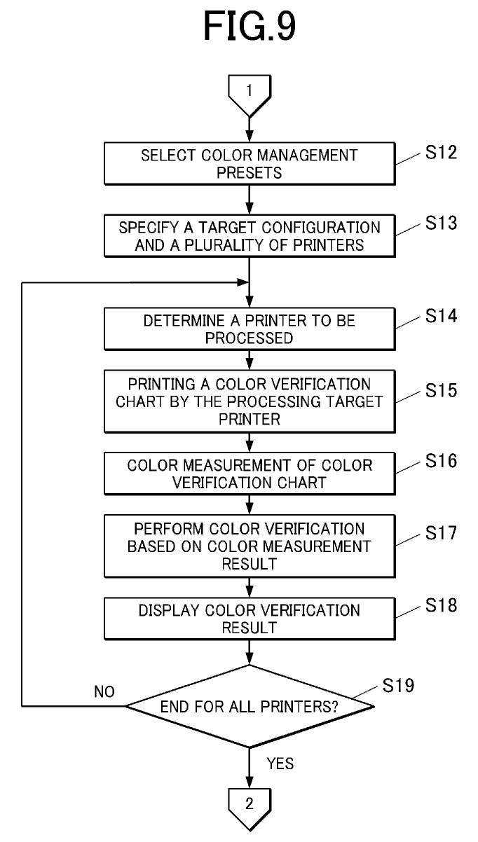

FIGS. 8 and 9 are flowchart illustrating the first color management processing executed in PC10.

As a premise of the first color management processing, the controller 11 executes color adjustment and color verification for the printer 20 (first image forming apparatus) serving as a standard of color management and creates a printer profile in advance. Hereinafter, the printer 20 which is a standard of color management is referred to as a "standard printer". The standard printer is a printer 20 used as a standard when color matching is performed so that a plurality of printers 20 (image forming apparatuses) can perform printing in the same color.

In the first color management process, first, the controller 11 creates a target configuration (first data set) (step S1). Specifically, the controller 11 creates a target configuration with the color reproduction characteristics of a standard printer (first image forming apparatus) as a target. The controller 11 creates a target configuration in order to adjust the colors of the plurality of printers 20 to be subjected to distributed printing to the color space of the printer profile of the standard printer.

When a user instructs creation of a target configuration by an operation from the operation part 13, the controller 11 causes the display part 12 to display a target configuration registration screen.

The user specifies the setting content for each setting item (see FIG. 4) of the target configuration by an operation from the operation part 13.

For example, the user specifies the printer profile of the standard printer as the "target profile" included in the "CMYK-CMYK device-link file" of the "device-link file" for the "color adjustment" of the "target configuration". Thus, the controller 11 can adjust the printer 20 as the color management target to the color reproduction characteristics of the standard printer.

The user specifies the printer profile of the standard printer as the "color verification target profile" included in the "color verification settings" for the "color verification" of the "target configuration". Furthermore, the user specifies, for the "color verification" of the "target configuration", an allowable value name customized for the standard printer as the "allowable value name" included in the "allowable value setting". By these settings, the controller 11 can verify whether or not the printer 20 which is the color management target can reproduce the color reproduction characteristics of the standard printer.

The user instructs completion of registration of the target configuration by an operation from the operation part 13. The controller 11 registers the set information in the target configuration table T2 of the storage section 15 as one target configuration in association with each other.

Next, the controller 11 associates one target configuration with a plurality of printers 20 (n printers 20) to create a color management preset (second data set) (step S2). Specifically, the controller 11 creates a color management preset that matches the color reproduction characteristics of the standard printer (first image forming apparatus).

When a user instructs creation of a color management preset by an operation from the operation part 13, the controller 11 causes the display part 12 to display a color management preset registration screen.

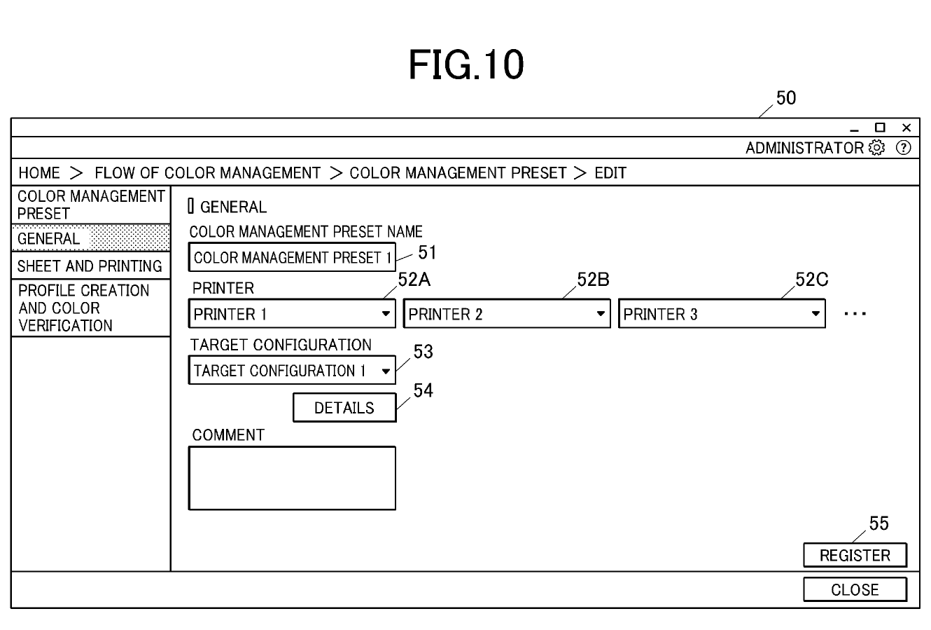

FIG. 10 illustrates an example of a color management preset registration screen 50. The color management preset registration screen 50 includes a color management preset name input field 51, printer selection fields 52A, 52B, 52C, and ***, a target configuration selection field 53, a detail button 54, and a registration button 55.

The user inputs a color management preset name in the color management preset name input field 51 by an operation on the operation part 13.

In each of the printer selection fields 52A, 52B, 52C, and ***, the controller 11 displays the printers 20 registered in the printer information table T1 as options. The user selects the plurality of printers 20 that the user wants to adjust to the color of the standard printer in the printer selection fields 52A, 52B, 52C, and *** by an operation from the operation part 13.

The controller 11 allows target configurations registered in the target configuration table T2 to be displayed as options in the target configuration selection field 53. The user selects one target configuration in the target configuration selection field 53 by an operation from the operation part 13.

When the button 54 is pressed, the content of the selected target configuration is displayed.

Note that although not illustrated in FIG. 10, on the color management preset registration screen 50, it is also possible to specify "sheet setting" and "print setting" of "sheet printing information" constituting "color management preset".

In this way, the user specifies the setting content for each setting item (see FIG. 5) of the color management preset by the operation from the operation part 13.

For color management to match the color reproduction characteristics of a standard printer, the user specifies, as a "target configuration" constituting a "color management preset", a target configuration targeting the color reproduction characteristics of the standard printer.

The user can also specify, as the "color management target printers" constituting the "color management preset", multiple printers 20 having a color gamut greater than or equal to the color gamut in the printer profile of the standard printer set in the "target configuration" constituting the "color management preset".

When the user presses the registration button 55 of the color management preset registration screen 50 by the operation from the operation part 13, the controller 11 registers the information set for the color management preset in the color management preset table T3 of the storage section 15 in association with each other.

Next, the controller 11 allows the display part 12 to display a selection screen for a color management function. The selection screen for the color management function is a screen for selecting color adjustment or color verification. The user selects color adjustment or color verification by an operation from the operation part 13. The controller 11 determines whether color adjustment or color verification has been selected in the selection screen for the color management function (step S3).

When the color adjustment is selected (step S3; color adjustment), the controller 11 accepts selection of a color management preset (step S4).

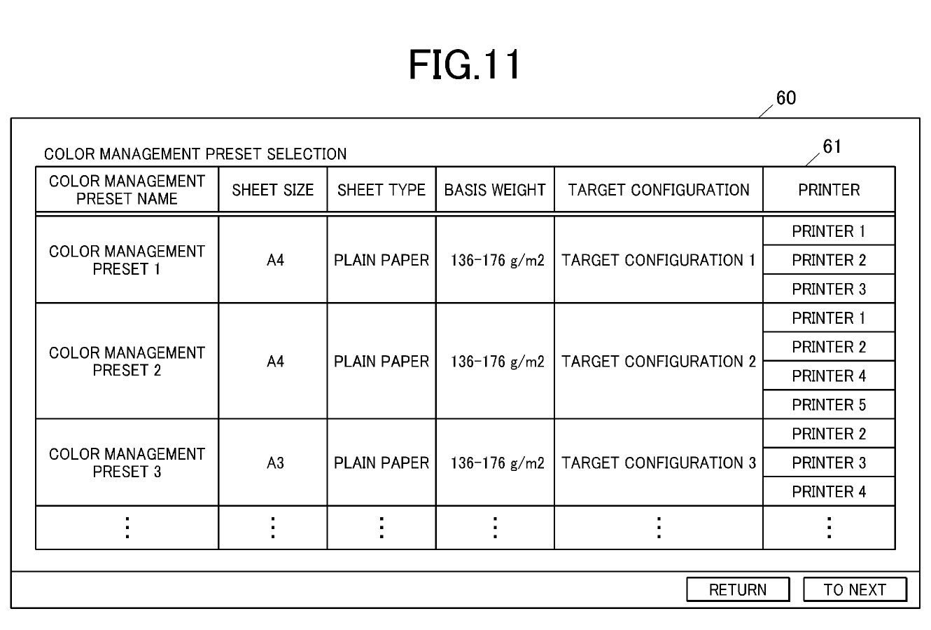

FIG. 11 illustrates an example of a color management preset selection screen 60 displayed on the display part 12. The color management preset selection screen 60 includes a color management preset list field 61. The controller 11 displays a list of color management presets registered in the color management preset table T3 in the color management preset list field 61.

The user selects one of the color management presets in the color management preset list field 61 by an operation from the operation part 13.

Next, the controller 11 identifies the target configuration included in the selected color management preset and the plurality of printers 20 (n printers 20) (step S5). That is, when the user selects the color management preset, the target configuration is selected.

Next, the controller 11 determines the printer 20 to be processed among the plurality of specified printers 20 (the plurality of printers 20 designated by the color management preset) (step S6).

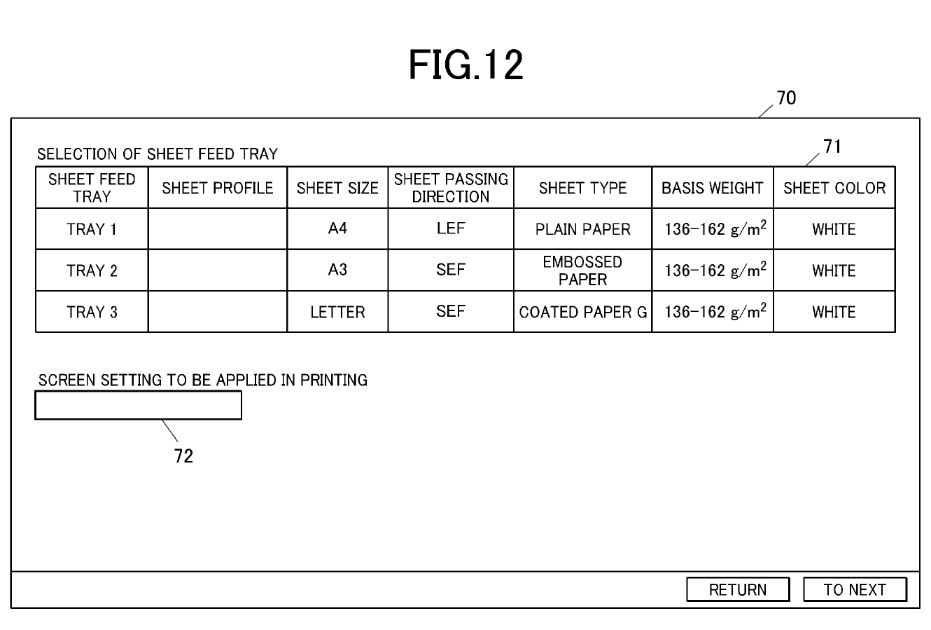

Here, the controller 11 causes the display part 12 to display a sheet feed tray selection screen 70 shown in FIG. 12 for the printer 20 to be processed. The sheet feed tray selection screen 70 includes a sheet feed tray list field 71, a screen setting field 72, and the like. The controller 11 refers to the printer information table T1 and acquires the sheet information corresponding to the printer 20 to be processed. The controller 11 allows the sheet feed tray list field 71 to display, for each sheet feed tray, the sheet information (sheet profile, sheet size, sheet feeding direction, sheet type, basis weight, and sheet color) corresponding to the printer 20 to be processed. In the sheet feed tray list field 71, the most suitable option (sheet feed tray) is automatically selected by default based on the "sheet setting" under the "sheet printing information" set for the selected color management preset. The controller 11 refers to the color management preset table T3 and causes the "screen" of the "print setting" included in the selected color management preset to be displayed in the screen setting field 72.

The user selects any one of the sheet feed trays in the sheet feed tray list field 71 by an operation from the operation part 13. The color adjustment is performed using the sheet in the sheet feed tray selected here.

Note that the controller 11 may acquire the latest sheet information from the printer 20 to be processed via the communication section 14. The controller 11 determines whether or not the target sheet of the color adjustment is set in the sheet feed tray included in the printer 20 of the processing target based on the acquired paper information. In a case where the target sheet of the color adjustment is not set in any sheet feed tray of the printer 20, the controller 11 may cause the display part 12 to display a warning screen and prompt the user to check and set the sheet. Furthermore, when the user selects a wrong sheet feed tray, the controller 11 may cause the display part 12 to display a warning screen.

Next, the controller 11 allows the display part 12 to display a chart printing screen for color adjustment.

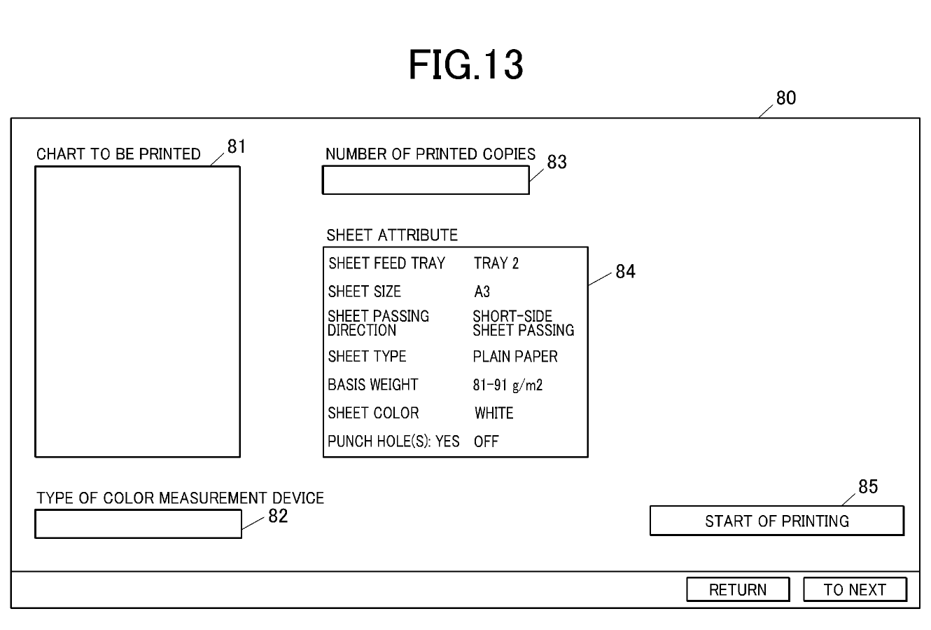

FIG. 13 illustrates an example of a chart printing screen 80. The chart printing screen 80 includes a chart preview field 81, a color measurement device field 82, a number of printed copies field 83, a sheet attribute field 84, a printing start button 85, and the like.

A "profile creation chart" included in the "target configuration" identified in step S5 is previewed in the chart preview file 81.

The "color measurement device" included in the "target configuration" identified in step S5 is displayed in the color measurement device field 82.

In the number-of-printed-copies field 83, the "number of copies" of the "print setting" included in the "color management preset" selected in step S4 is displayed.

In the sheet attribute field 84, "sheet setting" included in the "color management preset" selected in step S4 is displayed. Note that in a case where the sheet corresponding to the sheet feed tray selected on the sheet feed tray selection screen 70 does not match the "sheet setting" included in the "color management preset", information on the sheet corresponding to the sheet feed tray selected on the sheet feed tray selection screen 70 is displayed in the sheet attribute field 84.

The user presses the printing start button 85 on the chart printing screen 80 to instruct to start printing of the chart.

The controller 11 causes the printer 20 to be processed to print a profile creation chart (step S7). The controller 11 causes the profile creation chart to be printed based on the "target configuration" and the "sheet print information" included in the "color management preset" selected in step S4. The profile creation chart includes a patch group of a plurality of colors. The controller 11 transmits a print instruction to print the profile creation chart to the printer 20 to be processed via the communication section 14.

The controller 21 of the printer 20 to be processed controls the image forming section 26 to print a profile creation chart. Here, the controller 21 causes the profile creation chart to be printed without applying the existing profile. That is, the controller 21 does not perform color conversion during printing of the profile creation chart. Further, the controller 21 causes the profile creation chart to be printed using the sheet of the sheet feed tray selected on the sheet feed tray selection screen 70.

Next, the controller 11 of the PC10 causes the display part 12 to display a color measurement screen.

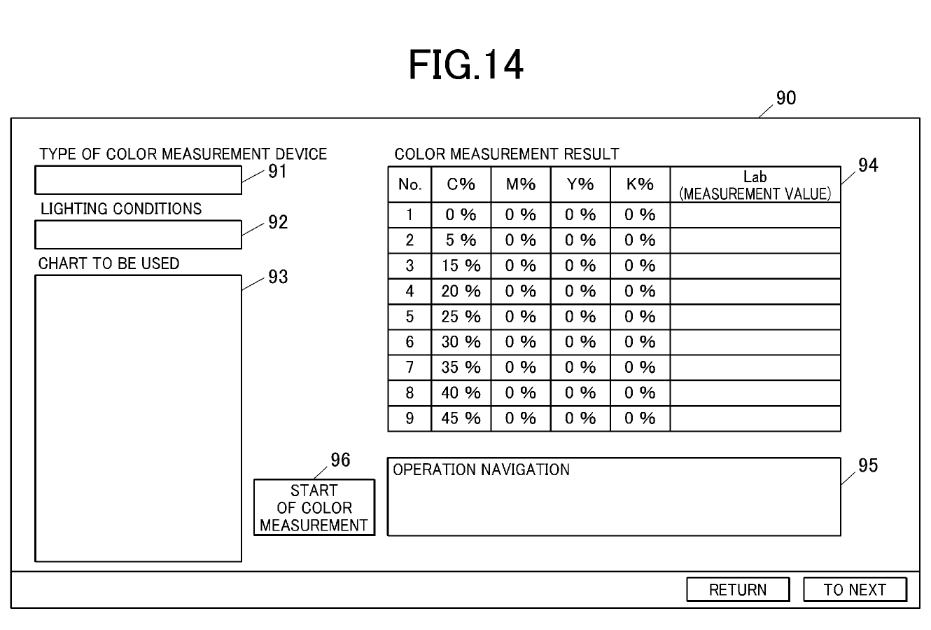

FIG. 14 illustrates an example of the color measurement screen 90. The color measurement screen 90 includes a color measurement device field 91, an illumination condition field 92, a chart field 93, a color measurement result field 94, an operation navigation field 95, a color measurement start button 96, and the like.

The "color measurement device" included in the "target configuration" identified in step S5 is displayed in the color measurement device field 91.

The "illumination condition" included in the "target configuration" specified in step S5 is displayed in the illumination condition column 92.

The "profile creation chart" included in the "target configuration" identified in step S5 is displayed in the chart field 93.

The color measurement result field 94 displays the color measurement result of each patch included in the profile creation chart. Before the color measurement, the color measurement result field 94 is blank.

In the operation navigation field 95, operation guidance for the user is displayed.

The user sets a profile creation chart in the color measurement device 40 and presses the color measurement start button 96 on the color measurement screen 90 to instruct to start color measurement of the chart.

The controller 11 causes the color measurement device 40 to measure the color of each patch of the profile creation chart (step S8). The controller 11 causes the profile creation chart to be subjected to color measurement on the basis of the "target configuration" identified in step S5. The controller 11 receives the color measurement result (colorimetric value) from the color measurement device 40 via the color measurement data receiver 16. The controller 11 allows the color measurement result of each patch to be displayed in the color measurement result field 94 of the color measurement screen 90.

In a case where the printer 20 to be processed includes the inline color measurement device 28, the following processing is performed in step S8.

The controller 11 of the PC10 causes the printer 20 to be processed to perform color measurement of each patch of the profile creation chart. The controller 11 sends a colorimetry instruction for a profile creation chart to the printer 20 to be processed via the communication section 14.

The controller 21 of the printer 20 to be processed controls the inline color measurement device 28 to measure the color measurement of the profile creation chart. The in-line color measurement device 28 performs color measurement of each patch of the profile creation chart. The controller 21 acquires a color measurement result (colorimetric value) from the in-line color measurement device 28. The controller 21 sends the color measurement result (colorimetric value) to the PC10 via the communication section 24.

The controller 11 of the PC10 acquires the colorimetry result from the printer 20 to be processed via the communication section 14.

After step S8, the controller 11 of the PC10 creates a color conversion profile based on the color measurement result (step S9). The controller 11 creates a color conversion profile on the basis of the "target configuration" identified in step S5. For example, the controller 11 creates a printer profile and a device link profile.

Next, the controller 11 allows the display part 12 to display a profile registration screen.

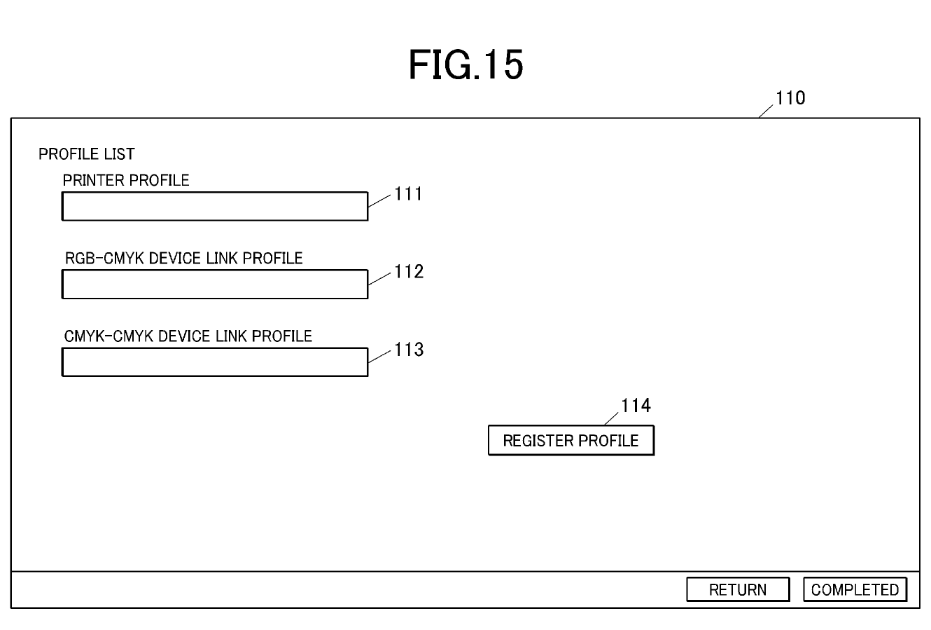

FIG. 15 illustrates an example of a profile registration screen 110. The profile registration screen 110 includes a printer profile file 111, a RGB-CMYK device-link profile file 112, a CMYK-CMYK device-link profile file 113, a "register profile" button 114, and the like.

A printer profile field 111 is an area for inputting a name to be given to the "printer profile" created in step S9.

The RGB-CMYK device-link profile field 112 is an area for inputting a name to be given to the "RGB-CMYK device-link profile" created in step S9.

The CMYK-CMYK device-link profile field 113 is an area for inputting a name to be given to the "CMYK-CMYK device-link profile" created in step S9.

When the user presses the "register profile" button 114 of the profile registration screen 110 by an operation from the operation part 13, the controller 11 registers the created color conversion profile in the printer 20 to be processed (step S10). The controller 11 sends the created color conversion profile and an instruction to register the color conversion profile to the printer 20 to be processed via the communication section 14.

In the printer 20 to be processed, the controller 21 causes the storage section 25 to store the color conversion profile transmitted from the PC10, and updates the color conversion profile.

Next, the controller 11 of the PC10 determines whether the processing has been completed for all the printer 20 (n printer 20) specified in the color management preset (step S11).

In a case where there is a printer 20 for which the process is not completed among the plurality of printers 20 designated by the color management preset (step S11; NO), the process returns to step S6. The controller 11 repeats the processes of steps S6 to S10 for another printer 20 among the plurality of printers 20 specified in the color management preset.

In step S11, in a case where the process is completed for all the printer 20 designated by the color management preset (step S11; YES), the first color management process is completed.

When color verification is selected in step S3 (step S3; color verification), the process proceeds to step S12 in FIG. 9. Since the processes of step S12 and step S13 are the same as the processes of step S4 and step S5, the description thereof will be omitted. Also in step S12, similarly to step S4, the color management preset selection screen 60 illustrated in FIG. 11 is displayed on the display part 12.

Next, the controller 11 determines the printer 20 to be processed among the plurality of printers 20 specified in step S13 (the plurality of printers 20 designated by the color management preset) (step S14).

The selection of the sheet feed tray is the same as in the case of "color adjustment" except that the color management is "color verification". A sheet feed tray selection screen 70 illustrated in FIG. 12 is displayed on the display part 12.

Next, the controller 11 allows the display part 12 to display a chart printing screen for color verification.

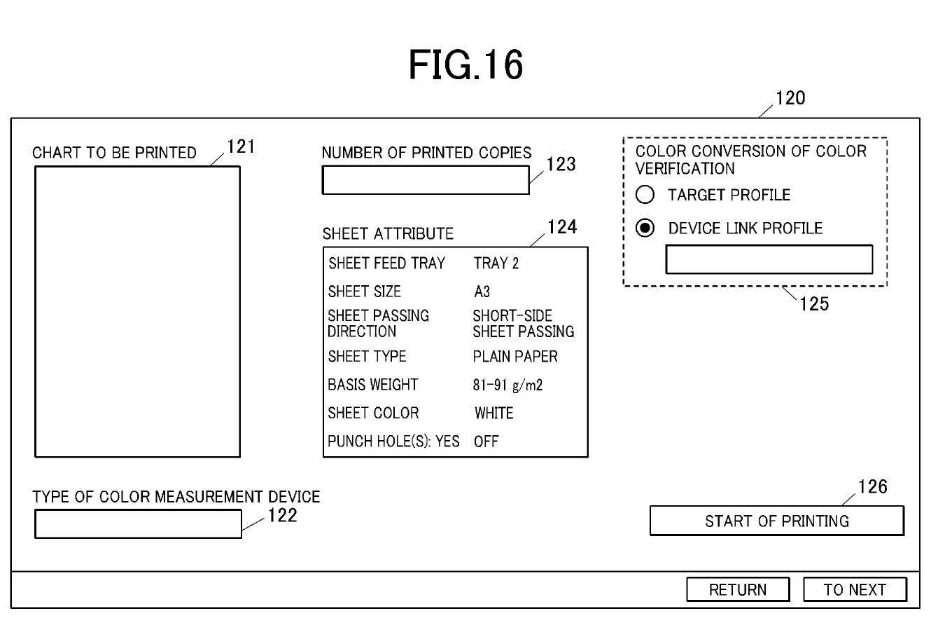

FIG. 16 illustrates an example of a chart printing screen 120. The chart printing screen 120 includes a chart preview field 121, a color measurement device field 122, a number of printed copies field 123, a sheet attribute field 124, a color conversion designation field 125 for color verification, a printing start button 126, and the like.

A "color verification chart" included in the "target configuration" identified in step S13 is previewed in the chart preview field 121.

The "color measurement device" included in the "target configuration" identified in step S13 is displayed in the color measurement device field 122.

In the number of printed copies field 123, the "number of copies" of the "print setting" included in the "color management presets" selected in step S12 is displayed.

In the sheet attribute field 124, "sheet setting" included in the "color management preset" selected in step S12 is displayed. Note that in a case where the sheet corresponding to the sheet feed tray selected on the sheet feed tray selection screen 70 does not match the "sheet setting" included in the "color management preset", information on the sheet corresponding to the sheet feed tray selected on the sheet feed tray selection screen 70 is displayed in the sheet attribute field 124.

The color verification color conversion designation field 125 is an area for designating a profile (target profile, device link profile) used for color verification color conversion.

The user presses a button 126 on the chart print screen 120 to give an instruction to start printing the chart.

The controller 11 causes the printer 20 to print a color verification chart (step S15). The controller 11 causes a color verification chart to be printed on the basis of the "target configuration" and the "sheet printing information" included in the "color management preset" selected in step S12. The color verification chart includes patch groups in a plurality of colors. The controller 11 transmits a print instruction of the color verification chart to the printer 20 to be processed via the communication section 14.

The controller 21 of the printer 20 to be processed controls the image forming section 26 to print a color verification chart. Here, the controller 21 performs color verification using the CMYK profile specified in the color conversion specification field 125 for color verification, and then causes the color verification chart to be printed.

Next, the controller 11 of the PC10 causes the display part 12 to display a screen similar to the colorimetry screen 90 shown in FIG. 14. Here, a color verification chart is displayed in the chart column 93. The color measurement result of each patch included in the color verification chart is displayed in the color measurement result field 94.

The user sets the color verification chart in the color measurement device 40, and instructs the start of color measurement of the chart by an operation from the operation part 13.

The controller 11 causes the color measurement device 40 to perform color measurement of each patch of the color verification chart (step S16). The controller 11 causes the color verification chart to be measured for color measurement based on the "target configuration" specified in step S13. The controller 11 receives the color measurement result (colorimetric value) from the color measurement device 40 via the color measurement data receiver 16.

When the printer 20 to be processed includes the in-line color measurement device 28, the controller 11 acquires the color measurement result of the color verification chart from the printer 20 to be processed via the communication section 14.

Next, the controller 11 of the PC10 executes color verification on the basis of the color measurement result (step S17). The controller 11 executes color verification on the basis of the "target configuration" identified in step S13. The controller 11 compares the color measurement result with the allowable value for each determination item, and determines whether or not the color printed by the printer 20 to be processed satisfies the color reproduction characteristics of the standard printer.

Next, the controller 11 allows the display part 12 to display the color verification result (step S18).

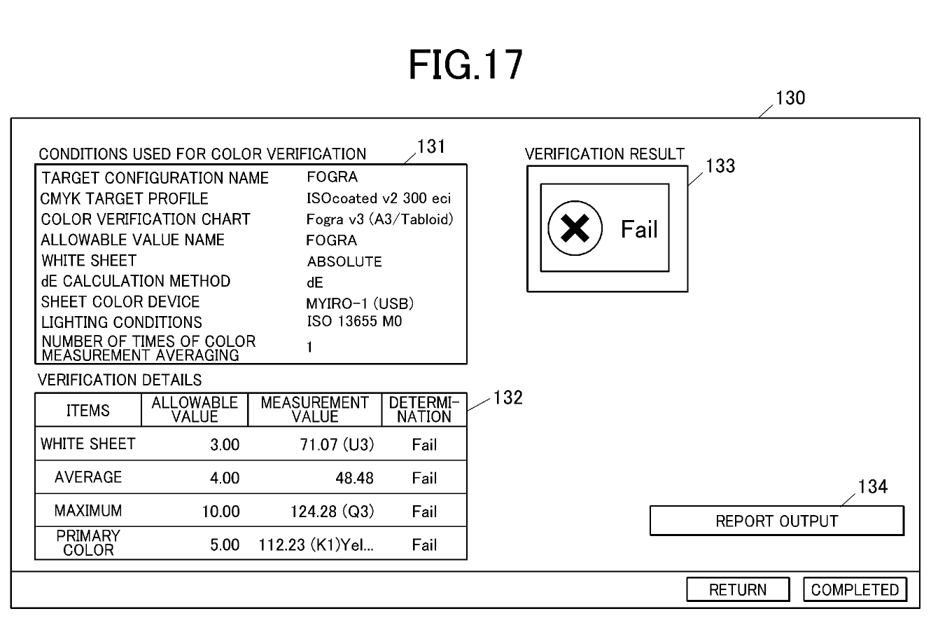

FIG. 17 illustrates an example of a color verification result screen 130. The color verification result screen 130 includes a color verification condition field 131, a verification detail field 132, a verification result field 133, and a report output button 134.

Conditions used for color verification are displayed in the color verification condition field 131.

Details of the color verification result are displayed in the verification details field 132. For example, in the verification details field 132, an allowable value, a measurement value, a determination result (Fail/Pass), and the like are displayed for each determination item. Note that the measurement values also include values calculated from the colorimetric values.

In the verification result field 133, "Fail" or "Pass" is displayed as a comprehensive determination result of the color verification.

The report output button 134 is a button for giving an instruction to output a report on color verification.

Next, the controller 11 determines whether the processing has been completed for all the printers 20 (n printers 20) specified in the color management preset (step S19).

In the case where there is a printer 20 for which the processing has not been completed among the plurality of printers 20 specified in the color management preset (step S19; NO), the process returns to step S14. The controller 11 repeats the processes of step S14 to step S18 for another printer 20 among the plurality of printers 20 specified in the color management preset.

In step S19, when the process is finished for all the printer 20 designated by the color management preset (step S19; YES), the first color management process is finished.

In the color management system 100 according to the first embodiment, when distributed printing is performed, a standard printer and printers 20 having a color gamut equal to or wider than the color gamut of the standard printer are registered in the print server 30 as printers 20 to be used for distributed printing. Among the printers 20 used for distributed printing, the printers 20 other than the standard printer are color-matched (color adjustment and color verification) so as to be able to perform printing with the same color as the standard printer. Registration of the printer 20 to be used for distributed printing in the server 30 may be manually performed by an administrator of the color management system 100. Alternatively, PC10 or the server 30 or the like may automatically detect a printer 20 satisfying the conditions within the network as the printer 20 to be used for distributed printing and register it in the server 30.

At the time of distributed printing, upon receiving a specification of print data to be printed from a user's operation of the operation part 13, the controller 11 of the PC10 sends a distributed printing instruction including the specified print data to the print server 30 via the communication section 14.

Based on the distributed printing instruction received from the PC10, the controller 31 of the server 30 distributes the print data-based print job to the plurality of printers 20 registered as the printers 20 to be used for distributed printing. For example, the controller 31 may equally distribute jobs to the printer 20. Furthermore, the controller 31 may distribute the jobs to the respective printer 20 in consideration of the load, job history, status of use of consumables, and the like of the respective printer 20. The controller 31 sends a print instruction including print data to each printer 20 via the communication section 32.

By performing printing based on the same print data in each printer 20, printed material having uniform color reproducibility can be obtained.

As described above, according to the first embodiment, the controller 11 of the PC10 accepts selection of a color management preset (step S4 and step S12), thereby accepting selection of a target configuration (first data set) to be used for color management. The controller 11 identifies n printer 20 (image forming apparatus) associated with the selected target configuration (step S5 and step S13). The controller 11 executes color management based on the target configuration for each of the n printers 20 (step S6 to step S11 and step S14 to step S19). Therefore, the controller 11 can easily perform color management for securing unified color reproducibility on the plurality of printer 20. The controller 11 can reduce the complexity of color management in the plurality of printers 20 that perform distributed printing. The controller 11 can provide execution of color management for securing unified color reproducibility even for a general operator who does not have expert knowledge.

In particular, in the first embodiment, a color management preset (second data set) in which all of the n printers 20 are associated with the target configuration is prepared as the setting information used for color management. Therefore, the controller 11 can easily execute the color management based on the selected color management preset for each of the n printer 20 by receiving the selection of the color management preset.

The target configuration also includes information indicating the color reproduction characteristics of a standard printer (first image forming apparatus). For example, in "color adjustment" of "target configuration", the printer profile of the standard printer is included as the "target profile" in the "CMYK-CMYK device-link file" of the "device-link file". Furthermore, in the "color verification" of the "target configuration", the printer profile of the standard printer is included as the "color verification target profile" in the "color verification setting". In addition, in the "color verification" of the "target configuration", the allowable value name customized for the standard printer is included as the "allowable value name" in the "allowable value setting". These settings enable the controller 11 to adjust the color management target printer 20 to the color reproduction characteristics of the standard printer.

The target configuration includes a setting of a CMYK target profile or a setting of an RGB source profile. To be specific, in the "color adjustment" of the "target configuration", the "target profile" is included in the "CMYK-CMYK device-link file" of the "device-link file". In the "color adjustment" of the "target configuration", the "RGB source profile" is included in the "RGB-CMYK device-link file" of the "device-link file". Based on these settings, the controller 11 can create a color conversion profile for each of the n printers 20.

The target configuration also includes setting of a target profile or setting of an allowable value in color verification. Specifically, in the "color verification" of the "target configuration", the "color verification setting" includes the "color verification target profile". Furthermore, in the "color verification" of the "target configuration", the "allowable value setting" includes the "allowable value name" and the "determination item and allowable value". Based on these settings, the controller 11 can verify color reproduction for each of the n printers 20.

In addition, the color management preset includes at least one setting of a sheet type, a basis weight, and a sheet color of a sheet used for color management. Specifically, the "sheet printing information" of the "color management preset" includes "sheet setting". Based on these settings, the controller 11 can execute color management for each of the n printers 20.

In addition, in the color management preset, n printers 20 selected on the basis of the color reproduction characteristics of the standard printer (first image forming apparatus) among m printers 20 are associated with the target configuration. Thus, the controller 11 can secure uniform color reproducibility for the n printers 20.

Note that as an alternative to step S1 of the first color management process, the user may specify a standard printer, and the controller 11 may automatically create a target configuration targeting the color reproduction characteristics of the specified standard printer. To be specific, the controller 11 automatically sets, for the "target configuration", the printer profile of the standard printer as the "target profile" included in the "CMYK-CMYK device-link profile" of the "device-link profile" of the "color adjustment". Furthermore, the controller 11 automatically sets, for the "target configuration", the printer profile of the standard printer as the "color verification target profile" included in the "color verification settings" of the "color verification". In addition, the controller 11 automatically sets the allowable value name customized for the standard printer as the "allowable value name" included in the "allowable value setting" of the "color verification" with respect to the "target configuration".

In addition, in step S2 of the first color management process, the controller 11 may automatically select n printers 20 capable of reproducing the color reproduction characteristics of the standard printer designated by the user. Specifically, the controller 11 selects n printers 20 having a color gamut equal to or wider than the color gamut in the printer profile of the standard printer. The controller 11 may automatically create a color management preset by associating the selected n printers 20 with a target configuration targeting the standard printer.

In a case where n printers 20 capable of reproducing the color reproduction characteristics of the standard printer are selected, if the n printers 20 are selected from among the m printers 20 in descending order of color gamut, the performance of the printers 20 may become excessive with respect to the required print quality. To avoid this, the controller 11 may select the n printers 20 having the narrowest color gamuts from among the printers 20 having color gamuts equal to or wider than the color gamut in the printer profile of the standard printer.

[Second Embodiment] Next, a second embodiment to which the present disclosure is applied will be described.

Since the color management system according to the second embodiment has the same configuration as the color management system 100 according to the first embodiment, the same constituent elements as those according to the first embodiment are denoted by the same reference signs, and description thereof is omitted. Hereinafter, characteristic configurations and processes of the second embodiment will be described.

The second embodiment is similar to the first embodiment in that a plurality of printers 20 are associated with a single target configuration. The second embodiment is different from the first embodiment in that the color management preset in which the target configuration and the printer 20 are associated with each other is individually managed for each printer 20.

The setting item (see FIG. 4) of the target configuration managed in the target configuration table T2 are the same as those in the first embodiment.

The setting item (see FIG. 5) of the color management presets managed in the color management preset table T3 are also the same as those in the first embodiment. Provided that in the second embodiment, a plurality of printers 20 cannot be set as the "color management target printer" for a single "color management preset", and only one printer 20 can be set.

The controller 11 receives a selection of a single target configuration (first data set) to be used for color management.

The controller 11 identifies n printers 20 (image forming apparatus) associated with the selected target configuration.

The controller 11 executes color management based on the selected target configuration for each of the n printers 20.

The controller 11 receives, for each of the n printers 20, selection of n color management presets (second data sets) associated with the printer 20 and a target configuration.

The controller 11 executes color management for each of the n printers 20 on the basis of a color management preset corresponding to the printer 20 among the n color management presets.

Each of n printers 20 selected on the basis of the color reproduction characteristics of the printer 20 (first image forming apparatus) as the standard of color management among m printers 20 is associated with the target configuration, and n color management presets are configured.

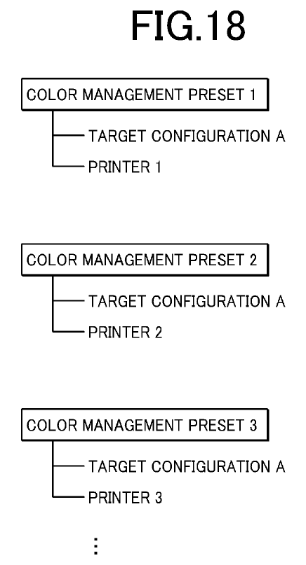

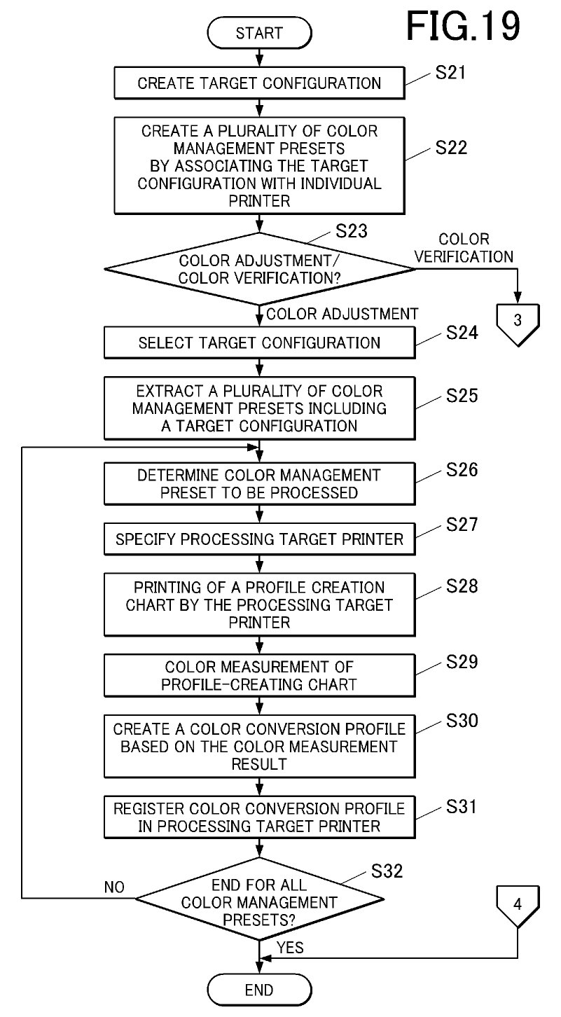

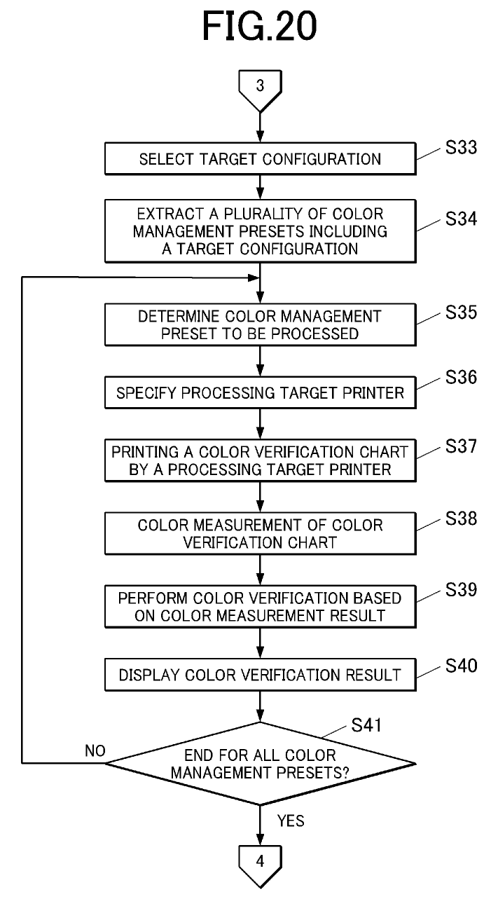

FIG. 18 is an image diagram of a plurality of color management presets (n color management presets) created in the second embodiment. Each color management preset is formed by associating the same target configuration with an individual printer 20.

Next, the operation of the color management system 100 according to the second embodiment will be described.

Flowcharts 19 and 20 are flowcharts illustrating second color management processing executed at the PC10.

As a premise of the second color management processing, the controller 11 executes color adjustment and color verification for a standard printer (first image forming apparatus) and creates a printer profile in advance.

The creation of a target configuration (step S21) is similar to the processing in step S1 in the first color management processing, and therefore, description thereof is omitted.

The controller 11 creates a target configuration in order to adjust the colors of the plurality of printers 20 to be subjected to distributed printing to the color space of the printer profile of the standard printer.

Next, the controller 11 associates one target configuration with each printer 20 to create a plurality of color management presets (step S22). The controller 11 creates n color management presets by associating one target configuration with each of the n printers 20.

The user selects one target configuration by an operation on the operation part 13 and selects a plurality of printers 20 that the user wants to adjust to the color of the standard printer. In addition, the user inputs a color management preset name corresponding to each of the plurality of color management presets by an operation from the operation part 13. The user also specifies, by operation of the operation part 13, the "sheet setting" and the "print setting" in the "sheet printing information" constituting each "color management preset" as common settings for the plurality of color management presets.

Specifically, for each of the plurality of selected printers 20, the controller 11 creates a color management preset that matches the color reproduction characteristics of the standard printer (first image forming apparatus).

The user specifies a target configuration targeting the color reproduction characteristics of the standard printer as a "target configuration" constituting each "color management preset".

The user also specifies, as the "color management target printer" constituting each "color management preset", the printer 20 having a color gamut greater than or equal to the color gamut in the printer profile of the standard printer set in the "target configuration" constituting the "color management preset".

The controller 11 creates a color management preset for each of the plurality of selected printers 20 and registers the color management preset in the color management preset table T3 of the storage section 15.

Next, the controller 11 determines whether color adjustment is selected or color verification is selected on the selection screen of the color management function (step S23).

When color adjustment is selected (step S23; color adjustment), the controller 11 accepts selection of a target configuration (step S24).

The controller 11 causes a list of target configurations registered in the target configuration table T2 to be displayed.

The user selects one of the target configurations from the list of the target configurations by an operation on the operation part 13.

Next, the controller 11 refers to the color management preset table T3 and extracts a plurality of color management presets (n plurality of color management presets) including the selected target configuration (step S25). That is, when the user selects the target configuration, a plurality of color management presets are selected.

Next, the controller 11 determines a color management preset to be processed among the plurality of extracted color management presets (the plurality of color management presets including the same target configuration) (step S26).

Next, the controller 11 identifies the printer 20 included in the determined color management preset as the printer 20 to be processed (step S27).

Here, the controller 11 causes the display part 12 to display a sheet feed tray selection screen 70 shown in FIG. 12 for the printer 20 to be processed.

The user selects one of the sheet feed trays in the sheet feed tray list field 71 on the sheet feed tray selection screen 70 by an operation on the operation part 13. The color adjustment is performed using the sheet in the sheet feed tray selected here.

The processes of step S28 to step S31 are the same as the processes of step S7 to step S10 in the first color management process, and therefore, description thereof is omitted. The controller 11 creates a color conversion profile based on the "target configuration" and the "sheet printing information" included in the "color management preset" determined in step S26.

Next, the controller 11 determines whether the processing has been completed for all the color management presets (n color management presets) including the same target configuration (step S32).

When there is a color management preset that has not been processed among the plurality of color management presets including the same target configuration (step S32; NO), the process returns to step S26. The controller 11 repeats the processing of step S26 to step S31 for another color management preset among the plurality of color management presets including the same target configuration.

In step S32, when the processing is completed for all the color management presets including the same target configuration (step S32; YES), the second color management processing ends.

When color verification is selected in step S23 (step S23; color verification), the process proceeds to step S33 in step S20. Since the processes of step S33 and step S34 are the same as the processes of step S24 and step S25, the description thereof will be omitted.

Next, the controller 11 determines a color management preset to be processed among a plurality of color management presets (a plurality of color management presets including the same target configuration) extracted in step S34 (step S35).

Next, the controller 11 identifies the printer 20 included in the determined color management preset as the printer 20 to be processed (step S36).

Here, the controller 11 causes the display part 12 to display a sheet feed tray selection screen 70 shown in FIG. 12 for the printer 20 to be processed.

The user selects one of the sheet feed trays in the sheet feed tray list field 71 on the sheet feed tray selection screen 70 by an operation on the operation part 13. The color verification is performed using the sheet in the sheet feed tray selected here.

The processes of step S37 to step S40 are the same as the processes of step S15 to step S18 in the first color management process, and thus the description thereof will not be repeated. The controller 11 executes the color verification based on the "target configuration" and the "sheet printing information" included in the "color management preset" determined in step S35.

Next, the controller 11 determines whether the processing has been completed for all the color management presets (n color management presets) including the same target configuration (step S41).

When there is a color management preset for which the processing has not been completed among the plurality of color management presets including the same target configuration (no in step S41), the processing returns to step S35. The controller 11 repeats the processing of step S35 to step S40 for another color management preset among the plurality of color management presets including the same target configuration.

In step S41, if the processing is completed for all the color management presets including the same target configuration (step S41; YES), the second color management processing ends.

In the color management system 100 according to the second embodiment, distributed printing is performed in the same manner as in the first embodiment.

As described above, according to the second embodiment, the controller 11 of the PC10 accepts selection of a single target configuration (first data set) used for color management (step S24 and step S33). The controller 11 specifies n printers 20 (image forming apparatus) associated with the selected target configuration (steps S27 and S36). The controller 11 executes color management based on the target configuration for each of the n printer 20 (step S28 to S31 and step S37 to S40). Therefore, the controller 11 can easily perform color management for securing unified color reproducibility on the plurality of printers 20. The controller 11 can reduce the complexity of color management in the plurality of printers 20 that perform distributed printing. The controller 11 can provide execution of color management for securing unified color reproducibility even for a general operator who does not have expert knowledge.

In particular, in the embodiment, for each of the n printer 20, n color management presets (second data sets) in which the printer 20 and the target configuration are associated with each other are prepared as the setting information used for the color management. Upon receiving selection of a target configuration (steps S24 and S33), the controller 11 receives selection of n color management presets including the target configuration (steps S25 and S34). As a result, the controller 11 can easily execute color management based on the color management preset corresponding to the printer 20 for each of the n printers 20.

In addition, in the n color management presets including the common target configuration, each of the n printers 20 selected based on the color reproduction characteristics of the standard printer (first image forming apparatus) among the m printers 20 is associated with the target configuration. Thus, the controller 11 can secure uniform color reproducibility for the n printers 20.

In the second embodiment, effects other than the effect produced by the data configuration of the color management preset are the same as those in the first embodiment.

As an alternative to step S21 of the second color management process, the user may specify a standard printer, and the controller 11 may automatically create a target configuration targeting the color reproduction characteristics of the specified standard printer.

Furthermore, in step S22 of the second color management process, the controller 11 may automatically select the n printers 20 that can reproduce the color reproduction characteristics of the standard printer specified by the user. Specifically, the controller 11 selects n printer 20 having a color gamut equal to or wider than the color gamut in the printer profile of the standard printer. The controller 11 may automatically create n color management presets by associating each of the selected n printers 20 with a target configuration targeted for the standard printer.

Note that the description in each of the above embodiments is an example of the color management method, the color management apparatus, and the program according to the present disclosure, and the present disclosure is not limited thereto. The detailed configuration and detailed operation of each device constituting the system can also be appropriately changed without departing from the spirit of the present disclosure.

For example, in each of the above-described embodiments, the case where the color conversion profile is created as the color adjustment has been described as an example, but the present invention is not limited thereto. The color adjustment may be maximum density adjustment, in-plane unevenness adjustment, tone curve adjustment, or the like.

Furthermore, in each of the above-described embodiments, in the first color management processing or the second color management processing, creation of a target configuration, creation of a color management preset, and color management (color adjustment or color verification) have been described as continuous processing. Instead of this, the controller 11 of the PC10 may individually execute the creation of the target configuration, the creation of the color management preset, the color adjustment, and the color verification as independent processes.

In each of the above-described embodiments, a case where the printer 20 is an electrophotographic image forming apparatus that forms an image using toner has been described, but the invention is not limited thereto. The printer 20 may be an image forming apparatus using any other printing method such as an inkjet method.

The computer-readable medium that stores the program for executing each processing is not limited to the above-described example. Furthermore, a carrier wave may be applied as a medium for providing data of the program via a communication line.

The disclosed embodiment is for purposes of explanation and example only, and is not intended to be limiting. The scope of the present disclosure should be interpreted by the description in the claims.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. A color management method comprising:
receiving, by a color management apparatus, selection of a single first data set to be used for color management;
specifying, by the color management apparatus, n image forming apparatuses associated with the selected first data set, the n being greater than one; and
performing, by the color management apparatus, the color management based on the first data set for each of the n image forming apparatuses.

2. The color management method according to claim 1, comprising:
receiving selection of a second data set in which the n image forming apparatuses and the first data set are associated with each other; and
performing the color management based on the selected second data set for each of the n image forming apparatuses.

3. The color management method according to claim 1, comprising:
receiving, for each of the n image forming apparatuses, selection of n second data sets in which the image forming apparatus and the first data set are associated with each other; and
executing, for each of the n image forming apparatuses, the color management based on a second data set corresponding to the image forming apparatus among the n second data sets.

4. The color management method according to claim 1, wherein the first data set includes information indicating a color reproduction characteristic of a first image forming apparatus serving as a standard for the color management.

5. The color management method according to claim 1, wherein
the first data set includes a setting for a CMYK target profile or a setting for an RGB source profile, and
the color management includes creating a color conversion profile for each of the n image forming apparatuses based on the first data set.

6. The color management method according to claim 1, wherein
the first data set includes a setting of a target profile or a setting of an allowable value in color verification, and
the color management includes verifying color reproduction for each of the n image forming apparatuses based on the first data set.

7. The color management method according to claim 2, wherein
the second data set includes at least one setting of a type, a basis weight, and a sheet color of a sheet used for the color management, and
the color management is performed based on the second data set for each of the n image forming apparatuses.

8. The color management method according to claim 4, wherein
the color management apparatus is capable of cooperating with m image forming apparatuses, the m being greater than the n, and
the n image forming apparatuses selected from among the m image forming apparatuses based on the color reproduction characteristic of the first image forming apparatus are associated with the first data set.

9. A color management apparatus comprising a hardware processor for executing the color management method according to claim 1.

10. A non-transitory computer-readable storage medium storing a program for causing a computer to execute the color management method according to claim 1, the computer controlling a color management apparatus.
